(19) United States
(12) Patent Application Publication
(10) Pub. No.: US 2016/0246926 A1
(43) Pub. Date: Aug. 25, 2016

(54) STRUCTURED REFERRALS TO ENSURE CLOSED-LOOP COMMUNICATIONS BETWEEN SERVICE PROVIDERS

(71) Applicant: Passport Health Communications, Inc., Franklin, TN (US)

(72) Inventor: Hans P. Morefield, Katonah, NY (US)

(73) Assignee: Passport Health Communications, Inc., Franklin, TN (US)

(21) Appl. No.: 14/968,552

(22) Filed: Dec. 14, 2015

Related U.S. Application Data
(60) Provisional application No. 62/120,850, filed on Feb. 25, 2015.

(51) Int. Cl. G06F 19/00; G06F 21/62

(52) U.S. Cl. CPC G06F 19/322; G06F 21/6245

(57) ABSTRACT

Systems and methods for ensuring closed-loop communications between senders and receivers of referrals are of increasing importance to healthcare providers of all types. Healthcare providers are increasingly using electronic medical records to send referrals and other medical information between one another, but have no real way to ensure that a receiving party responds or that a reply includes useful or well-formatted information that is compatible with the original sender's systems. To ensure that receivers complete the communication loop with useful and well-formatted information, structured requests are incorporated into the referrals. Senders designate how a receiver may reply to a request as part of a referral and generate communications to ensure that receivers respond the referrals.

### RELATED APPLICATIONS

This application claims priority from U.S. Provisional Patent Application No. 62/120,850 titled, “SYSTEM AND METHOD FOR IMPROVING AND ENSURING CLOSED-LOOP PROVIDER REFERRALS” and having a filing date of Feb. 25, 2015, which is incorporated herein by reference.

### BACKGROUND

Primary care physicians (PCP) often refer patients to specialists, with an expectation that the patient will make an appointment with the specialist. Ideally, the specialist will examine the patient, and the specialist will advise the PCP on his/her findings and recommendations. In this ideal scenario, the specialist “closes the loop” by responding to the PCP with a consultation summary (also known as a ‘consult report’), which provides details about the physician's findings and the episode of care. This process serves as a foundation of care coordination and is essential to helping providers deliver more efficient and effective health care. Conceptually, these “closed-loops” sound simple; however, they often do not occur in the real world as described. In various studies, PCPs report not getting consult reports back for 40-45% of their referrals and as many as half of PCPs in some studies expressed dissatisfaction with the information they received from the referred physician's office.

Various solutions have been developed and deployed to improve the referral coordination process. These technologies include both standalone referral management systems and referral management functionality within electronic medical record (EMR), electronic health record (EHR), or health information exchange (HIE) systems, used by most physicians today. While these technologies have made it easier for the PCP to send referrals and for the specialist to receive referrals, the current technologies have not improved the return communication from the specialist to the PCP; the lack of closed-loop referrals still persists.

This issue exists beyond just PCP to specialist referrals. As the healthcare industry seeks to improve patient outcomes while also reducing the cost of care, more attention has been spent on other care transitions as well, such as the discharge of patients from hospitals back to their homes, to skilled nursing facilities (SNF), or other post-acute providers. These care transitions also involve, ideally, the communication of information from one provider to another to effect the hand-off of the patient's treatment, and to instruct the receiving provider on the patient's needs and the transitioning provider's recommendations for evaluation and treatment. These communications are sometimes referred to as “referrals,” but may also be termed “orders” or simply “communications.” For the purpose of this application, they will be termed referrals.

The sending providers of these referrals also struggle with the failed closed-loop. For example, a hospital that refers a discharged patient back to a PCP for a follow-up visit within a week of discharge, may never hear back whether this visit occurred, let alone the PCP's findings of the patient's health status and the adherence to discharge instructions. Similarly, when the hospital transitions the patient to a SNF, the hospital loses awareness of the patient's health and the duration of the patient's stay at the SNF. In either the case of the discharge to the home or to the SNF, there is a significant risk of the patient's condition worsening and the patient requiring readmission to the hospital.

Medicare may penalize hospitals for avoidable readmissions, even if the patient's health only changed after discharge. Thus, hospitals have a strong incentive to follow the patient's health after the patient has been discharged, but the lack of closed-loop processes with the providers to whom they refer patients upon discharge prevents hospitals from effectively and/or efficiently managing the patient's on-going care. In 2015, 75% of U.S. hospitals will be penalized financially by Medicare for not reducing avoidable readmissions sufficiently.

The current art for referral management includes locally-hosted and web-based systems, including patented systems, but the current art does not include functionality nor methods for: the referral sender to specify, in a structured format, requests for the referral receiver to respond to, the referral receiver to respond in structured form requested by the sender, or alerts to the referral receiver if they have not responded to these requests within a prescribed timeframe.

Many current applications, such as the scheduling.com solution (U.S. Pat. No. 8,538,779) and the Cerner solution (U.S. Patent Application 2013/0282397), include methods for ensuring the referral sender includes in the referral all the data required by the receiver referral. Additionally, other applications, including the IRIS system for rules-based referrals (U.S. Pat. No. 7,904,315), include methods for the sender to provide data in order for the appropriateness of the referral to be determined while incorporating real-time clinical decision support. The focus of the current art has been to automate referral delivery and manage received referrals, but without significant consideration for the referral response needs of the sender. Hence, the current issue with the lack of closed-loop referrals and the high percentage of providers indicating they fail to receive reports back at all, or receive incomplete information back from the destination provider.

In addition to the development and deployment of referral management systems, the health care industry, led by state and federal government initiatives, has worked to develop and implement standards to improve data sharing among industry participants. One such effort is known as Project Direct, an initiative to develop a standard approach and technical architecture for secure messaging among providers and between providers and patients. While Direct-compliant messages can be used for sending referrals and simplifying other provider-to-provider communications, they too do not improve the rate of closed-loop referrals. Direct-compliant messages are like email; other than attachments, the contents of the message is free-text (unstructured) and there is nothing inherent in Direct-compliant messages to ensure the referral receiver will respond to the referral sender, nor is there anything to ensure responses in the specific, structured form sought by the sender.

### BRIEF SUMMARY

This present disclosure provides systems and methods for the sender of a referral to specify, in a structured form, one or more requests to a receiver of the referral message, as well as the format for the responses to the requests, and provide means for the receiver to reply to the requests. The present disclosure also provides tracking of submitted requests and completed replies, by the sender and receiver, respectively, and the alerting of the receiver if the receiver has not replied to a request within the timeframe required by the sender. The systems and methods address the issues faced by referring providers of not knowing the status of their referrals, the results of the receiving provider's evaluation or treatment of the patient, and/or the patients' resulting health statuses.

Additionally, aspects of the present disclosure overcome problems specific to computers by improving the use of EMR systems in a way that is not possible in paper-based document systems. By integrating the present disclosure with EMR systems, referring physicians may be assured that referral receivers will respond in greater numbers with more useful treatment histories.

### BRIEF DESCRIPTION OF THE DRAWINGS

The accompanying drawings, which are incorporated in and constitute a part of this disclosure, illustrate various aspects and examples of the present invention. In the drawings:

FIG. 1A is a block diagram of an architecture for using a structured referral system for healthcare providers;

FIG. 1B is a block diagram of an architecture for using a structured referral system to communicate with patients;

FIG. 2A is a flow chart showing general stages involved in an example method for creating a referral with a structured request using the structured referral system;

FIG. 2B is a flow chart showing general stages involved in an example method for viewing the status of an existing referral and its replies with a structured request using the structured referral system;

FIG. 3 is a flow chart showing general stages involved in an example method for a receiver of a referral to view the referral and its requests and reply to the requests with structured answers using the structured referral system;

FIG. 4 is a flow chart showing general stages involved in an example method for applying a ruleset to a structured response to ensure ongoing care;

FIG. 5 is an example referring user interface for building structured referrals;

FIGS. 6A and 6B are example message user interfaces for a receiver to access a structured referral;

FIG. 7 is an example inbox user interface of a structured referral inbox for a receiver to check the status of received structured referrals;

FIGS. 8A and 8B are example outbox user interfaces of a structured referral outbox for a sender to check the status of sent referrals and the requests within; and

FIG. 9 is a block diagram illustrating physical components of an example computing device with which examples of the present invention may be practiced.

### DETAILED DESCRIPTION

The following detailed description refers to the accompanying drawings. Wherever possible, the same reference numbers are used in the drawings and the following description to refer to the same or similar elements. While aspects of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims. Examples may take the form of a hardware implementation, or an entirely software implementation, or an implementation combining software and hardware aspects. The following detailed description is, therefore, not to be taken in a limiting sense.

This present disclosure provides systems and methods for the sender of a referral to specify, in a structured form, one or more requests to a receiver of the referral, as well as the format for the responses to the requests, and provide means for the receiver to reply to the requests. The present disclosure also provides tracking of submitted requests and completed replies, by the sender and receiver, respectively, and the alerting of the receiver if the receiver has not replied to a request within the timeframe required by the sender. The systems and methods address the issues faced by referring providers of not knowing the status of their referrals, the results of the receiving provider's evaluation or treatment of the patient, and/or the patients' resulting health statuses.

Additionally, aspects of the present disclosure overcome problems specific to computers by improving the use of EMR systems in a way that is not possible in paper-based document systems. By integrating the present disclosure with EMR systems, referring healthcare providers may be assured that referral receivers will respond in greater numbers with more useful treatment histories.

The present disclosure improves upon the process of communication between healthcare providers regarding the referral of patients by requiring a response from the referred-to healthcare provider by providing systems and methods to incorporate structured requests into the referral that facilities the response to these requests. Unlike paper-based requests and previous electronic requests, which can be ignored or filled out improperly, the present disclosure introduces requirements by which the requests must be filled out. The requests and their structured form are defined by the referred-from healthcare provider so that a more useful response to close the referral loop is ensured.

As used herein, the term “request” comprises questions, tasks or instructions related to a “referral.” The term “referral” is to be understood to include all messages that relate to transfers in care of a patient, including, but not limited to: transfers to a healthcare provider in another field or location (e.g., a specialist, a physician at a different office), transfers to and from a hospital, transfers to home care, transfers to a skilled nursing facility, and transfers to other post-acute treatment facilities (e.g., physical therapy, general practitioners).

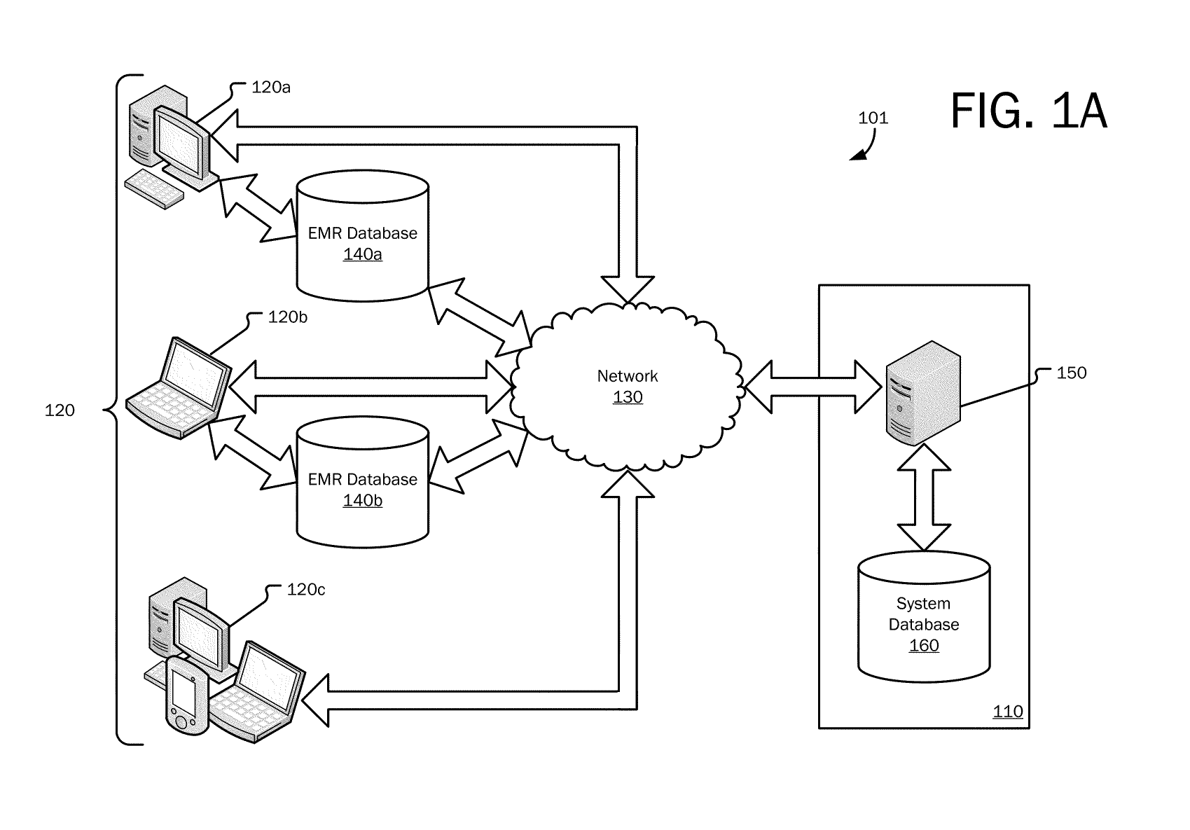

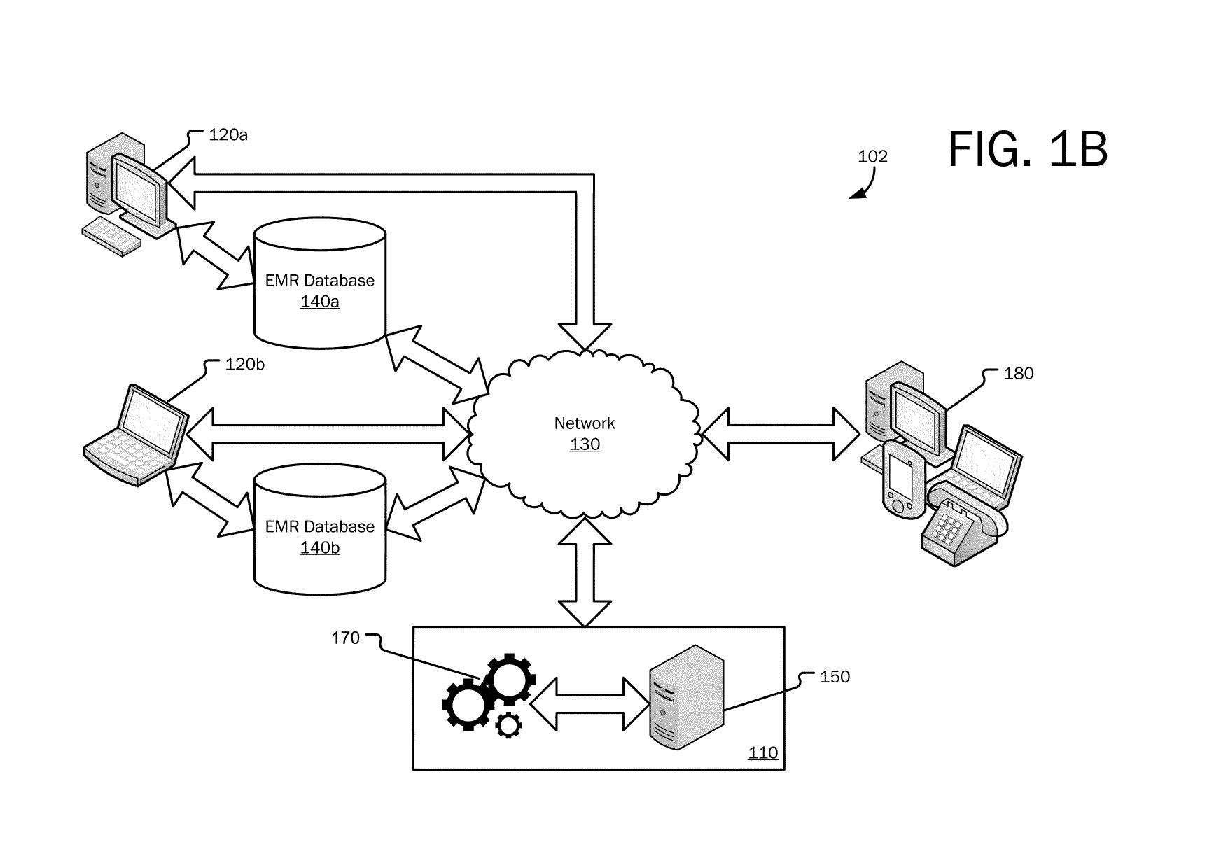

FIG. 1A is a block diagram of an architecture 101 for using a structured referral system 110 for healthcare providers. Within the architecture 101, remote computers 120, such as a sender's remote computer 120a, a receiver's remote computer 120b, and other providers' remote computers 120c (collectively, remote computers 120), are in communication with one another and the structured referral system 110 via a network 130. As will be understood, more or fewer remote computers 120 than illustrated in FIG. 1 may be in communication via the network 130 with one another and the structured referral system 110.

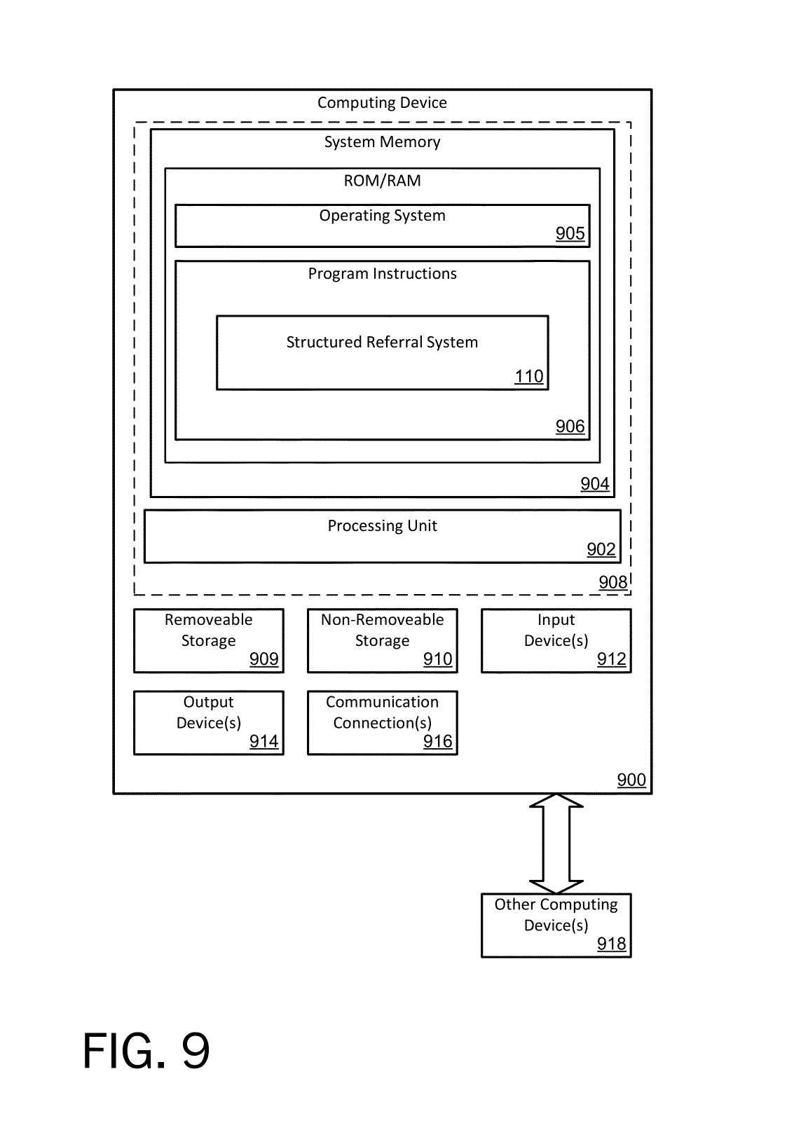

In various aspects, the remote computers 120 include desktop computers, laptop computers, tablet computers, mobile devices, server systems, and other computer devices operable to access the network 130 and the structured referral system 110 as discussed in further detail in FIG. 9. Although illustrated as a single computing device, it will be understood that a healthcare provider may have access to multiple computing devices for use as an associated remote computer 120. For example, a physician may be assigned both a desktop computer and a tablet computer by a hospital, and either computing device (or both) may be used in conjunction with the present disclosure.

The network 130 includes the internet and other networks (e.g., intranets) by which the remote computers 120 may communicate with one another and the structured referral system 110. The network 130 also includes telephone networks, such as cellular and Plain Old Telephone Service (POTS) networks, so that remote computers 120 may be communicated with via a phone call or a text message (e.g., short message service (SMS), multimedia message service (MMS), pager message).

In addition to the network 130, the remote computers 120 are in communication with associated Electronic Medical Records (EMR) databases 140, which are used for storing and processing EMRs related to the care history of patients seen by the associated healthcare provider. For example, the sender's remote computer 120a is in communication with the sender's EMR database 140a, whereas the receiver's remote computer 120b is in communication with the receiver's EMR database 140b. Although not illustrated for the other providers' remote computers 120c, one of skill in the art will understand that they too may be in communication with both an associated EMR database 140 and the network 130. In various aspects, EMR databases 140 are implemented in computer devices such as those discussed in further detail in FIG. 9.

The EMR databases 140 are in communication with the network 130 as well as the remote computers 120 of their associated healthcare providers so that electronic messages and electronic clinical documents (ECD) may be securely transferred between EMR systems. As will be understood, ECDs include sensitive information regarding patients, including medical histories, personally identifiable information (e.g., names, addresses, social security numbers), and payment information (e.g., bank routing numbers, credit card numbers, insurance providers), and are therefore protected under various privacy and disclosure laws. Often, to transfer ECDs, a patient must expressly approve the transfer of such documents between healthcare providers. One of skill in the art will be familiar with these laws and how to ensure that the transfers of ECDs comply with the relevant privacy and disclosure laws and best practices in the medical industry for ensuring physician-patient confidentiality of ECDs.

The structured referral system 110 includes an application server 150 and a system database 160, which may be implemented a single computer device or in a distributed system including multiple computer devices, such as those discussed in further detail in FIG. 9. The application server 150 is in communication with the network 130 and the system database 160 to provide the functionalities of the structured referral system 110 to healthcare providers. To communicate with the network 130, the application server 150 includes wired transceivers and wireless transceivers, which in various aspects include, but are not limited to: cellular network antennas for sending wireless communications via a cellular communication protocols (e.g., 4G, SMS, MMS), pager network antennas for sending wireless communications via pager protocols (e.g., Post Office Code Standardization Advisory Group (POCSAG), FLEX), and internet ports for sending wired communications via internet protocols (e.g., Transmission Control Protocol/Internet Protocol (TCP/IP), File Transfer Protocol (FTP), Post Office Protocol (POP), Internet Message Access Protocol (IMAP)). The system database 160 is used by the application server 150 to store system data, such as, but not limited to, referrals, requests, formats of previously submitted requests, lists of healthcare providers in communication with the structured referral system 110, and computer instructions for the execution of requests.

A healthcare provider accesses the structured referral system via an associated remote computer 120 and the network 130. Senders of referrals create referrals with associated requests in the structured referral system 110, which are stored in the system database 160. Receivers of referrals access the structured referral system 110 to view the stored referrals and to respond to the requests associated with the referrals. Alternatively, the receiver of a referral may access the referral within their associated EMR database 140.

FIG. 1B is a block diagram of an architecture 102 for using a structured referral system 110 to communicate with patients. In addition to coordinating and structuring the communication of treatment information between healthcare providers, the structured referral system 110 is further operable to enable communication with patients to ensure their compliance with a course of treatment based on the responses from a receiver.

To ensure that a patient's plan of care is being followed, the structured referral system 110 includes a rules engine 170 to process responses from receivers to determine whether patients are complying with their courses of treatment and to automatically respond if they are not. The rules engine 170 may be implemented by a single computer device or in a distributed system including multiple computer devices, such as the computing device discussed in further detail in FIG. 9. Depending on the replies received to requests, the rules engine 170 will process the reply and may generate a message to the a patient device 180 in response to determining that the reply indicates that the patient has deviated from the expected course of treatment.

Rules used by the rules engine 170 may be set by the healthcare provider or by the structured referral system 110 depending on the reply type expected. In one example, a request for confirmation of “Did the patient show up for the referral appointment” having a reply type of “Yes or No” may have a reply from the receiver of “No,” indicating that the patient did not show up for the scheduled referral appointment and is thus deviating from a course of treatment. In another example, a healthcare provider may refer a patient for the treatment of an eating disorder and include a request for the patient's weight as a number, and if the patient's weight is outside of a range (e.g., too high or too low) based on the patient's previous weight, the rules engine 170 will determine that the patient is deviating from a course of treatment. In these examples, the healthcare provider may determine that the deviation is worth following up on, and indicate to the rules engine 170 that a deviation should lead to a communication to the receiver or the patient.

The rules engine 170 is in communication with the application server 150 so that messages may be transmitted to patient devices 180 over the network 130 when it is determined from the replies that a patient is not following a course of treatment. The patient device 180 may include desktop computers, laptop computers, tablet computers, mobile devices (e.g., cellular telephones, smart phones, pagers), and wired telephones (POTS or IP) depending on the contact information provided by the patient. For example, when the patient has supplied a phone number, the message may be a phone call sent to the patient device 180 of a wired telephone or a mobile device, while if the patient has supplied an email address, the message may be an email message accessible by the patient device 180 of a desktop, laptop or tablet computer, or mobile device capable of reading email.

The rules engine 170 is also operable to transmit messages to the receiver's remote computer 120b or the receiver's EMR database 140b in response to a rule indicating that a patient is following a course of treatment. In one example, in response to an affirmative reply (e.g., a date or a “Yes”) to a request for whether the patient has scheduled an appointment, the rules engine 170 may extract relevant patient data from the sender's EMR database 140a and transmit it as a file to the receiver's EMR database 140b. In this way, the spread of ECDs and other potentially sensitive information is limited to healthcare providers who will actually need access to the documents, thus potentially reducing memory space requirements, reducing the amount of data transmitted, and improving the security of the information. Alternatively, the information may be sent to the receiver in an encrypted format, which is decrypted in response to a reply to an appropriate request. The structured referral thus act to improve closed-loop communications between healthcare providers by enforcing the receiver's reply to requests before enabling the receiver to access the patient's information.

The rules engine 170 is further operable to communicate back to the sender, via the sender's remote computer 120a or another communication device associated with the sender, to alert the sender or a member of the sender's organization that the patient has failed to follow through with a course of treatment, so that the sender may independently contact the patient or set up a subsequent referral. For example, when the patient is a no-show for an appointment with the receiver that has been properly accepted by the receiver. These communications back to the sender may also include additional requests from the receiver based on replies to one or more requests in the referral. For example, the receiver may request a more detailed medical history than was originally provided by the sender, which the rules engine 170 will use to adjust the requests with subsequent due dates in the referral to account for the new request.

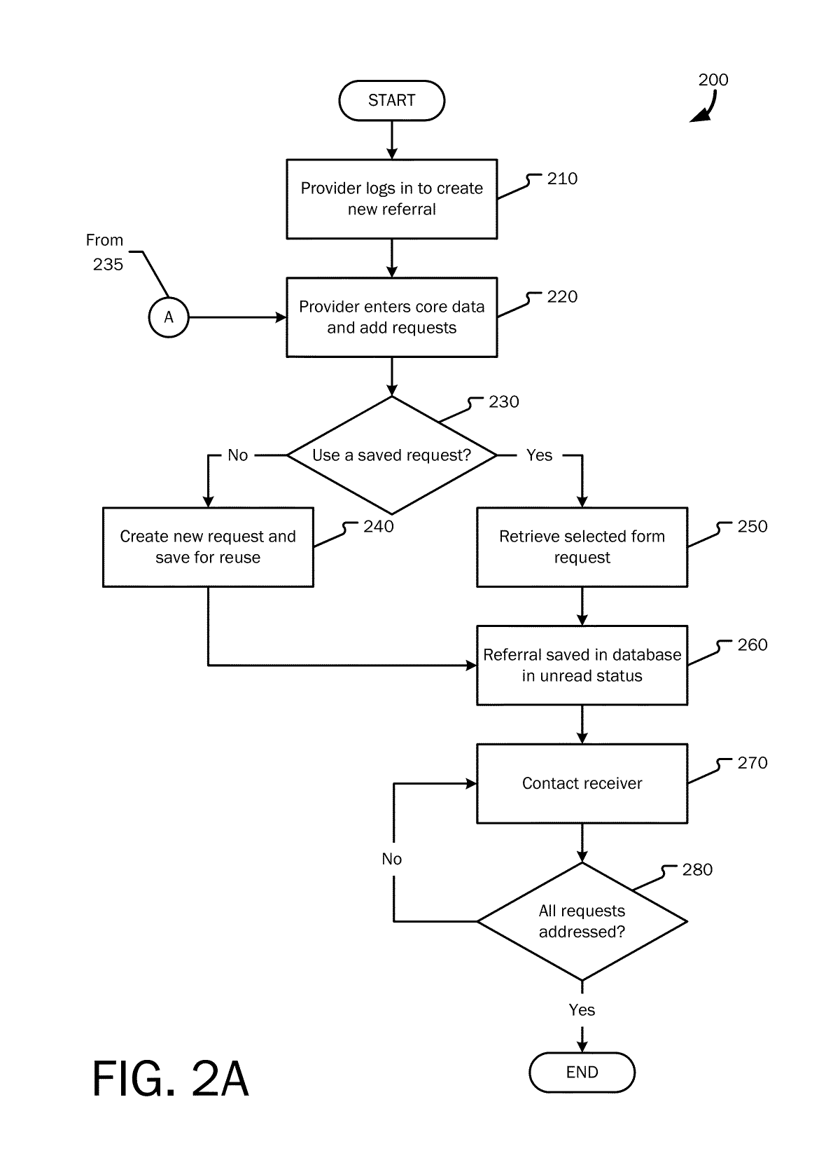

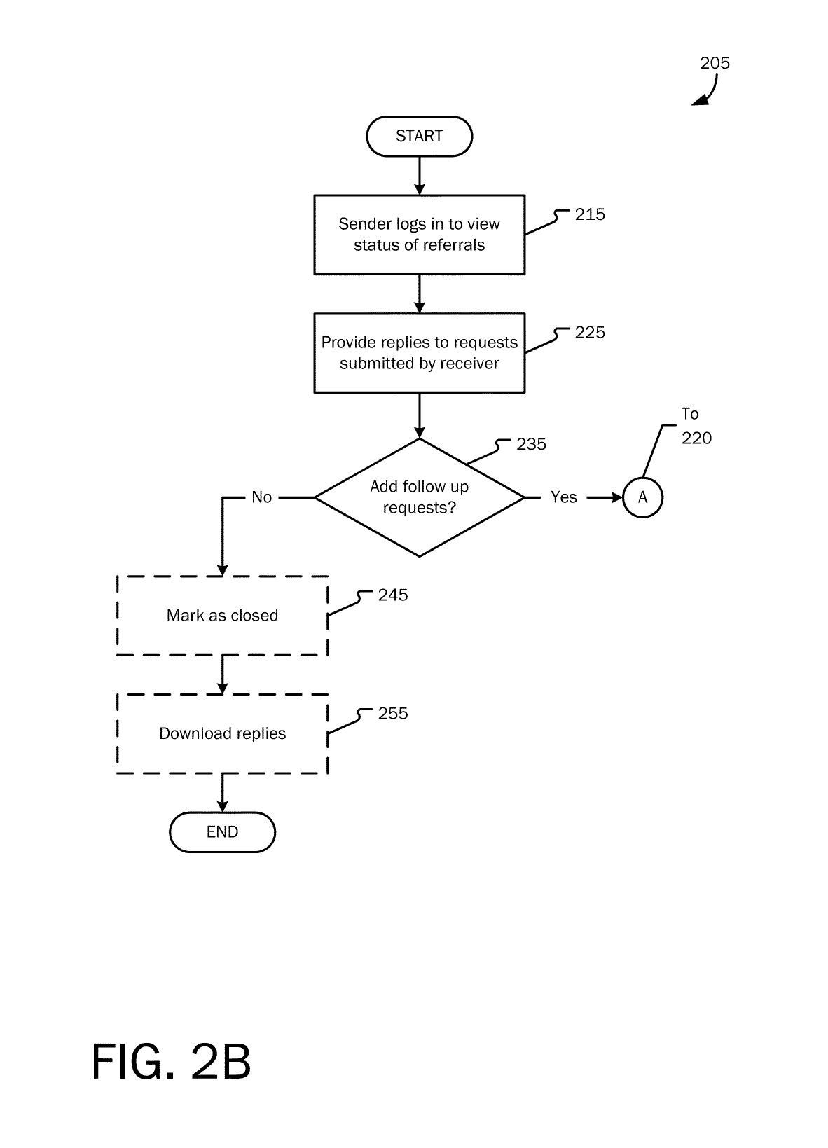

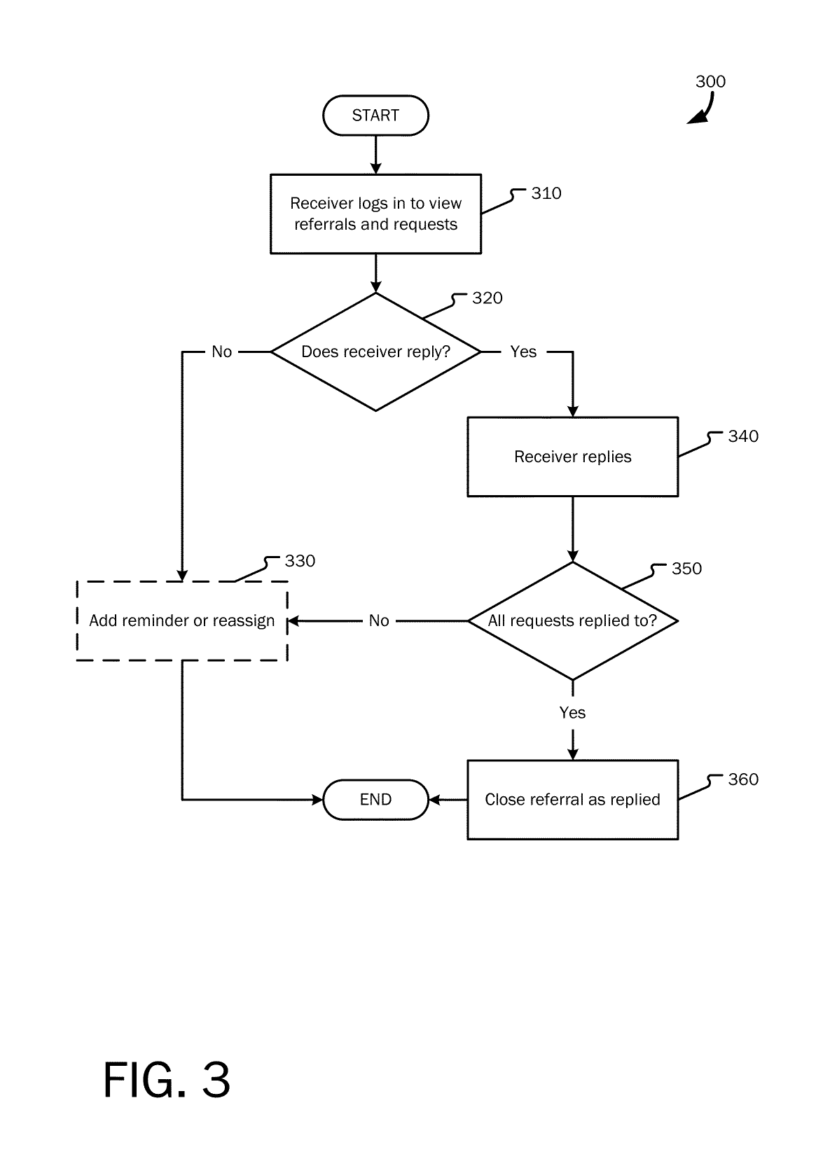

FIG. 2A is a flow chart showing general stages involved in an example method 200 for creating a referral with a structured request using the structured referral system 110. Method 200 begins at OPERATION 210 when a healthcare provider logs into the structured referral system 110 to create a new referral. In various aspects, logging in involves sending a username/password pair or other credentials that uniquely identify and authorize the use of the structured referral system 110 (e.g., passing credentials from another system via an authentication token). Upon successful login of the healthcare provider, method 200 proceeds to OPERATION 220. Alternatively, method 200 may proceed to OPERATION 220 from DECISION OPERATION 235, which is discussed in further detail in FIG. 3.

At OPERATION 220, the healthcare provider enters core data for the referral and adds at least one request for the receiver to complete as part of the referral. The core data include the components of a referral, including, but not limited to: the patient's demographic data, insurance data, the destination healthcare provider, sending healthcare provider data, and the reason for referral.

At DECISION OPERATION 230 it is determined whether the request to add to the referral from OPERATION 220 will use a saved request. When a healthcare provider chooses to not use a saved request, method 200 proceeds to OPERATION 240. Alternatively, a healthcare provider may select to use a previously used request or a pre-loaded request provided by the structured referral system 110, in which case method 200 proceeds to OPERATION 250. As will be appreciated, a healthcare provider may add multiple requests to single referral and the healthcare provider may independently choose whether to use a new or a saved request.

At OPERATION 240 the structured referral system 110 presents the healthcare provider with input fields to specify details about the request. These details include, but are not limited to: a descriptive form for the request, a reply type from the receiver required to complete the request, whether an attachment is required in the reply, a due date for the reply, how the due date is calculated (e.g., time from the referral's creation, time from the completion of a related request in the referral, a specific date/time), whether the request depends on another request associated with the referral (and which request), whether the request can be reassigned by the receiver, and whether the reply is required or optional. TABLE 1 illustrates several potential reply types that may be specified in a request. Reply types enable a sender to specify the format of a response from a receiver, and the receiver, when accessing the referral will only be presented the option to enter data matching the reply type specified by the sender. For example, when the sender specifies a reply type of “Multiple Choice”, the sender may specify the defined list of choices and the receiver will be presented the choices with a corresponding set of radio buttons or checkboxes to select only one or at least one of the defined list of choices, respectively. Other means of reply include, but are not limited to: radio buttons, checkboxes, text fields, date/time pickers, calendar selectors, clock selectors, text/number field, drop down lists, list boxes, slider bars, and spinners.

TABLE 1

| Reply Type | Accepted Inputs from Receiver |
|---|---|
| Yes/No | The system will limit the reply to Yes or No |
| Yes/No/N.A. | The system will limit the reply to Yes or No |
| | or Not Applicable |
| Yes/No/Unknown | The system will limit the reply to Yes or No |
| | or Unknown |
| Multiple Choice | The system will limit the reply to one selection |
| (select one) | from a pre-defined list of choices specified by |
| | the sender |
| Multiple Choice | The system will limit the reply to one or more |
| (select multiple) | selections from a pre-defined list of choices |
| | specified by the sender |
| Free Text-single line | The system will provide a single line text input field |
| Free Text-text box | The system will provide a text box input field |
| Numeric | The system will provide an input field which only |
| | allows for a numeric value |
| Date/Time | The system will provide an input field which only |
| | allows for valid date and time values |
| Date only | The system will provide an input field which only |
| | allows for valid a date value |
| Weight | The system will provide an input field marked as |
| | ‘lbs’ or ‘kg’ and limit the reply to a numeric value |
| | between 1 and 1500 |
| Patient's Vitals | The system will provide multiple input fields |
| | specific to a patient's vital signs (body temperature, |
| | pulse rate, respiration rate, blood pressure) and only |
| | accept numeric values |
| Email Address | The system will provide an input field which only |
| | allows for valid email address as a value |

At OPERATION 250 the healthcare provider selects a saved request. A saved request may be either a previously user-generated request or a “built-in” request that the structured referral system 110 has pre-loaded for the convenience of its users. A healthcare provider may save a request generated at OPERATION 240 with a descriptive name for later retrieval of the request, and may group several requests together under a single name so that the healthcare provider may select a suite of requests to use in a referral without having to select each component request individually.

In various aspects, the system automatically adds structured requests to a referral document. The referral is captured by the system and requests are added to the referral based on rules pre-defined by the sender (e.g., a post-discharge referral will always add the saved request “Reply with the Appointment Date”) before the referral is made available to the receiver via the receiver's EMR database 140b or the structured referral system 110.

Method 200 then proceeds to OPERATION 260, where the referral is saved in a database with an unread status for the associated requests. In various aspects, the referral, including its associated requests, may be saved to the system database 160 or the receiver's EMR database 140b depending on how the receiver will access the referral. In another aspect, the referral and its requests are mirrored between the system database 160 and the receiver's EMR database 140b. The unread status of the referral enables the sender to determine whether the receiver has viewed the referral yet, and when the receiver has viewed the referral, the status will be updated from ‘unread’ to ‘read’. In various aspects, the update from ‘unread’ to ‘read’ status is accompanied by a message being transmitted to the sender to indicate the change in status. In other aspects, a message to indicate a change in status is only sent when the receiver accepts the referral, which allows the receiver to reassign the referral to a third healthcare provider without the referral's status being changed until the referral is ultimately accepted.

In various aspects, the referral may be saved in an incomplete or “draft” state, to be completed at a later time. Draft referrals may be saved to the sender's EMR database 140a or the structured referral system 110 and may be completed by the original drafter or another authorized party. For example, a doctor may save a draft referral indicating the specialist the patient has been referred to, and an authorized administrator may add the requests to the draft referral to complete it. In another example, a nurse may generate a referral and include several requests in the draft of the referral, which the structured referral system will automatically add more requests to for the nurse or another authorized party to approve and thereby complete the referral.

When the referral is complete, method 200 proceeds to OPERATION 270, where the receiver of the referral is contacted. In various aspects, healthcare providers may specify various methods by which they wish to be contacted when they have been sent a referral or when a due date for replying to a request has been missed, and which of the methods is a preferred method to contact the healthcare provider. For example, the healthcare provider may specify one or more email address and one of more telephone numbers that can be used to contact the healthcare provider and which email address or telephone number should be used first to contact the healthcare provider. The structured referral system 110 will generate a communication that is transmitted to the preferred endpoint (email address or telephone number). For example, the structured referral system 110 may generate and transmit an email for an email address or a text message (an SMS or MMS message) for a telephone number.

In various aspects, the contents of the message generated for the receiver by the structured referral system 110 will contain varying levels of detail. For example, a message may alert the receiver that a new referral has been transmitted to them, the message may include a hyperlink to the referral in the structured referral system 110 or the receiver's EMR database 140b, or a summary the details of the referral may be included in the message. Depending on the security and capabilities of the receiver's remote computer 120b, the content of the message may be adjusted. For example, if the receiver's remote computer 120b is a mobile device, such as a cell phone or a pager, a text message or a pager notification may be sent, whereas if it is a desktop or laptop computer, an email with a summary of the details may be sent.

At DECISION OPERATION 280 it is determined whether the receiver has addressed all requests associated with the referral. If the receiver has addressed all of the requests included in the referral, method 200 concludes. If the receiver has yet to address all of the requests included in the referral by a corresponding due date for each request, method 200 returns to OPERATION 270, where the receiver is contacted to complete the requests within the referral. When the receiver has not addressed the requests by the original due date, a second due date is set by the structured referral system 110 so that the receiver may be contacted repeatedly until the requests have all been addressed. In various aspects, a subsequent due date may be based on a previous due date such that the same amount of time is given (e.g., n days between all due dates) or that progressively shorter amount of time are given between due dates (e.g., five days, then two days, then one day). In additional aspects, the communications for missed due dates may be sent to other email addresses or telephone numbers in addition to, or instead of, the preferred methods of contact to ensure that the communication is seen.

FIG. 2B is a flow chart showing general stages involved in an example method 205 for viewing the status of an existing referral and its replies with a structured request using the structured referral system 110. Method 205 begins at OPERATION 215 when a healthcare provider, who has previously sent a structured referral, logs into a system to view the status of its referrals, which may include sending a username/password pair or other credentials that uniquely identify the user and authorize the use of the system. In various aspects, the healthcare provider logs in to its EMR system to view the status of the referrals, while in other aspects, the healthcare provider logs into the structured referral system 110 to do so. Upon successful login, method 205 proceeds to OPERATION 225, where any replies to the referrals sent by the logged-in healthcare provider are provided. The referral sender can view the status of its referrals, the status of the requests included in the referrals, and a summary of its referrals or requests. Additionally, the referral sender may select a referral to view the details of any replies submitted by the referral's receiver(s).

At DECISION OPERATION 235 it is determined whether the sender will add any additional or follow up requests to the referral. In various aspects, the sender may add a request to a referral when it was omitted at the initial creation of the structured referral or in response to the receiver's reply for additional information. When it is determined that the sender will add an additional or follow up request to the referral, method 205 proceeds to OPERATION 220 of method 200, where the sender will proceed under the operations of method 200 to add the request. When it is determined that the sender will not add an additional or follow up request, method 205 may proceed to OPTIONAL OPERATION 245 and/or OPTIONAL OPERATION 255 before concluding.

At OPTIONAL OPERATION 245 the referral is marked as closed. In various aspects, a referral may be marked as closed when all requests have been replied to by the receiver, and the sender has declined to add follow up requests. In other aspects, such as, for example, where at least one request was an optional request, the referral may be marked as closed when all non-optional requests have been replied to by the receiver, and the sender has declined to add non-optional follow up requests. Additionally, a referral may be marked as closed at the sender's discretion when some or all of the requests have not been replied to, for example, when the patient has declined to seek the referred treatment.

At OPTIONAL OPERATION 255 the replies associated with a referral are downloaded from the system they were made in to the sender's EMR database 140a, the structured referral system 110, or another system from which the replies may be used as part of the sender's data analysis. Such analysis may include determining the speed of replying for the receiving healthcare providers individually or in aggregate, and patient follow up rates with the designated receiving healthcare providers.

FIG. 3 is a flow chart showing general stages involved in an example method 300 for a receiver of a referral to view a referral and its structured requests and reply to the requests with a structured request using the structured referral system 110. Method 300 begins when a receiver logs into the system to view referrals and requests at OPERATION 310, which may include sending a username/password pair or other credentials that uniquely identify the receiver and authorize the use of the system. In various aspects, the receiver may log into its EMR system to view its referrals or may log into the structured referral system 110 to view its referrals. In various aspects, requests are highlighted relative to their due dates, for example, requests that are due the day which they are accessed may be highlighted “yellow” and requests that have past their due data may be highlighted “red” in a user interface used to access referrals.

Method 300 proceeds to DECISION OPERATION 320 where it is determined whether the receiver replies to the referral. Depending on the nature of the request and the referral that the receiver is viewing, the receiver may not be able to reply yet to some or all of the requests. For example, a referral that includes a request for the appointment date, a request for whether the patient kept the appointment, and a request for a Continuity of Care Document, may not be fully replied to until the patient has been given an appointment date, the appointment date has arrived, and the patient been discharged after the appointment. Alternatively, the receiver may decide not to reply to a request that is possible to reply to. When a request is not replied to, method 300 may proceed to OPTIONAL OPERATION 330 before concluding. When a request is replied to, method 300 proceeds to OPERATION 340.

At OPTIONAL OPERATION 330 a referral may be reassigned or a reminder may be added to the referral by the receiver. In various aspects, when a receiver views a newly-sent referral, the status of the referral is updated to ‘read’ and a message may be sent to the sender unless the receiver reassigns the referral. A receiver may set a reminder to complete a referral or reply to a request at a later date. In various aspects, the receiver may designate a preferred method of being reminded, which may include, but is not limited to: an email, a text message, a pager message, and a pop-up generated by the system. The method of being reminded may activate messaging programs on the receiver's remote computer 120b or give focus to a messaging programming on the receiver's remote computer 120b (i.e., bring the messaging programing to the foreground of a display ahead of other active processes to capture the attention of a receiver).

When the receiver decides to reply to the referral, method 300 proceeds to OPERATION 340. At OPERATION 340 the receiver accesses the requests and inputs responses in the structured format of the request. The receiver may reply to all of the requests of a referral at one time, or the requests may be replied to at separate times. For example, a receiver may reply to a request for appointment setup information (e.g., referral acceptance, appointment date) before replying to a request for post-appointment information (e.g., a CCD, follow up appointments scheduled). When the receiver replies, the replies are saved to the system and the percentage that the referral is complete is updated. For example, a reply may be sent to the structured referral system 110 where it is stored, and the status of the referral will indicate that one more request has been completed out of the total number of requests associated with the referral.

At DECISION OPERATION 350 it is determined whether all the existing requests have been replied to. If it is determined that not all of the existing requests have been replied to, method 300 proceeds to OPTIONAL OPERATION 330 and concludes. If it is determined that all of the existing requests have been replied to, method 300 proceeds to OPERATION 360, where the referral is marked as completed.

When a referral is marked as completed, the structured referral system 110 may generate a notification for the sender to view the completed referral. In various aspects, the notification may be sent via an email, a text message, a pager message or another format to alert the sender that the referral has been marked as completed. The sender may accept this status, or may add follow up requests as discussed in further detail in relation to FIG. 2B.

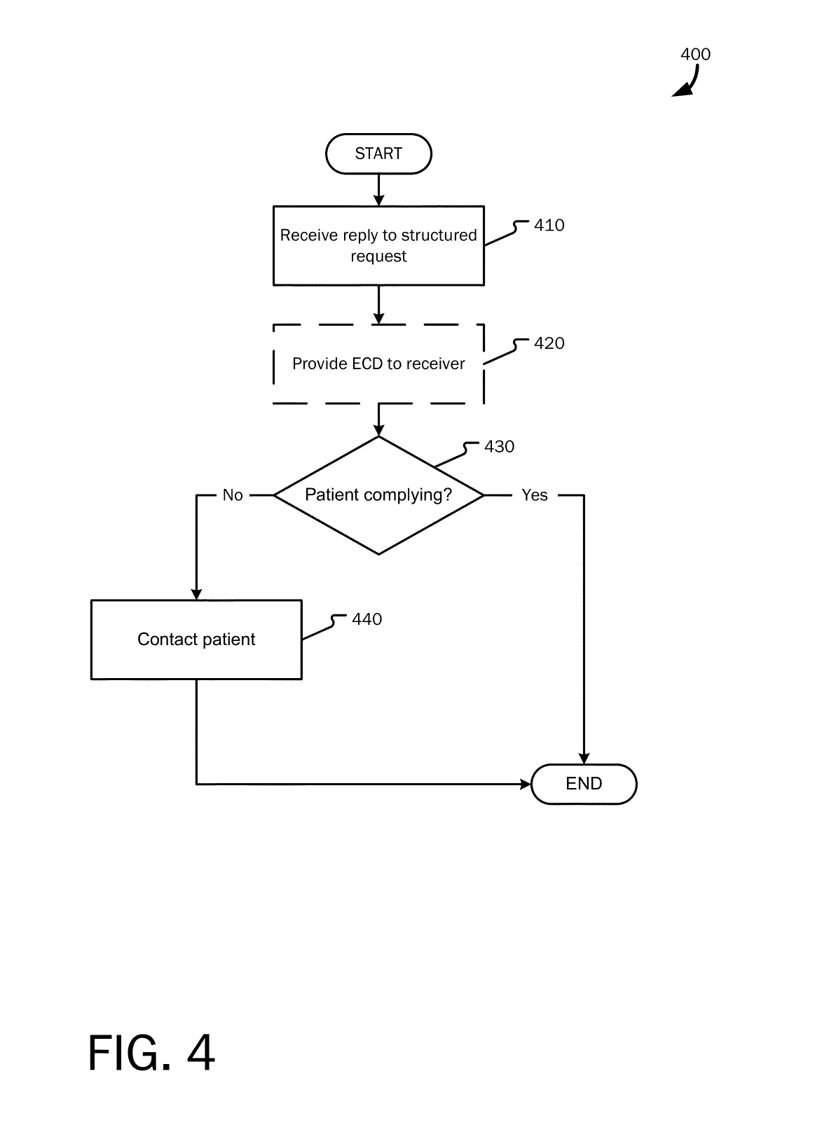

FIG. 4 is a flow chart showing general stages involved in an example method 400 for applying a ruleset with a structured request to ensure ongoing care. Method 400 begins when a reply to a structured request is received at OPERATION 410. In various aspects, the reply may be received by the sender's EMR database 140a or the structured referral system 110, and the reply may be in response to one or more requests associated with a given referral.

In various aspects, method 400 may proceed to optional OPERATION 420, where the referred patient's ECDs are provided to the receiver in response to the reply to the structured request. A patient's ECD may be provided by retrieving it from the sender's EMR database 140a and transmitting it to the receiver's EMR database 140b or transmitting it to the system database 160 and allowing the receiver access to the ECD on via the structured referral system 110. Alternatively, the ECD may have already been transmitted to the receiver's EMR database 140b or the system database 160, but is not made available to the receiver until it sends a reply to a request. For example, the ECD may have been transmitted at the time the referral was transmitted (e.g., as an attachment), but is encrypted until the receiver sends a reply, at which time the ECD will be unencrypted.

Method 400 proceeds to DECISION OPERATION 430, where it is determined whether the reply indicates that the patient is complying with the referred course of treatment or has deviated. In various aspects, the sender may set various ranges to requests that will be determined to be in compliance or deviating from a course of treatment for which the patient was referred. For example, a sender may include a request with a due date for when the patient needs to set up an appointment with the receiver. If the receiver indicates in a reply that the patient has not set up an appointment by that due date, the patient will be determined to be deviating from the course of treatment. Alternatively, if the receiver indicates in a reply that the patient has set up an appointment by that due date, the patient will be determined to be compliance with the course of treatment related to that request. As will be understood, a patient's compliance with a course of treatment requires compliance related to all requests; a patient found deviating from one request will be determined to not be in compliance.

When it is determined from the replies from the receiver that a patient is in compliance with a referred course of treatment, method 400 concludes. When it is determined from the replies from the receiver that a patient is not in compliance with a referred course of treatment, method 400 proceeds to OPERATION 440.

At OPERATION 440 the patient is contacted. In various aspects, the patient is contacted via a phone call, a text message, and/or an email, on a patient device 180 by either the sender or the structured referral system 110. The address or telephone number may be extracted from the ECD for the patient or provided by the patient at the time of referral in the event the sender healthcare provider needs to contact the patient. Patients may specify multiple methods by which they can be contacted when they have been determined to not be in compliance with a course of treatment, and which of the methods is a preferred method to contact the patient.

The contact message transmitted to contact the patient may activate a messaging application on the patient device 180 to cause the message to display on the patient device 180 and to enable the patient to respond to the contact message. For example, the contact message may include a hyperlink to a URL of the receiving healthcare provider's scheduling website so that the patient may reschedule a missed appointment. The contact message may also activate a calendar or alarm clock application on the patient device 180 to schedule appointments or times to take medications. In various aspects, the contact message may be sent to a remote computing device 120 of a third party indicated in the patient's ECD as an emergency medical contact instead of, or in addition to, transmitting the contact message to the patient.

Once a patient is contacted, the sender or receiver may follow up with the patient to create a new course of treatment (potentially including a new referral or new requests) to which the patient will be expected to adhere. Method 400 may then conclude.

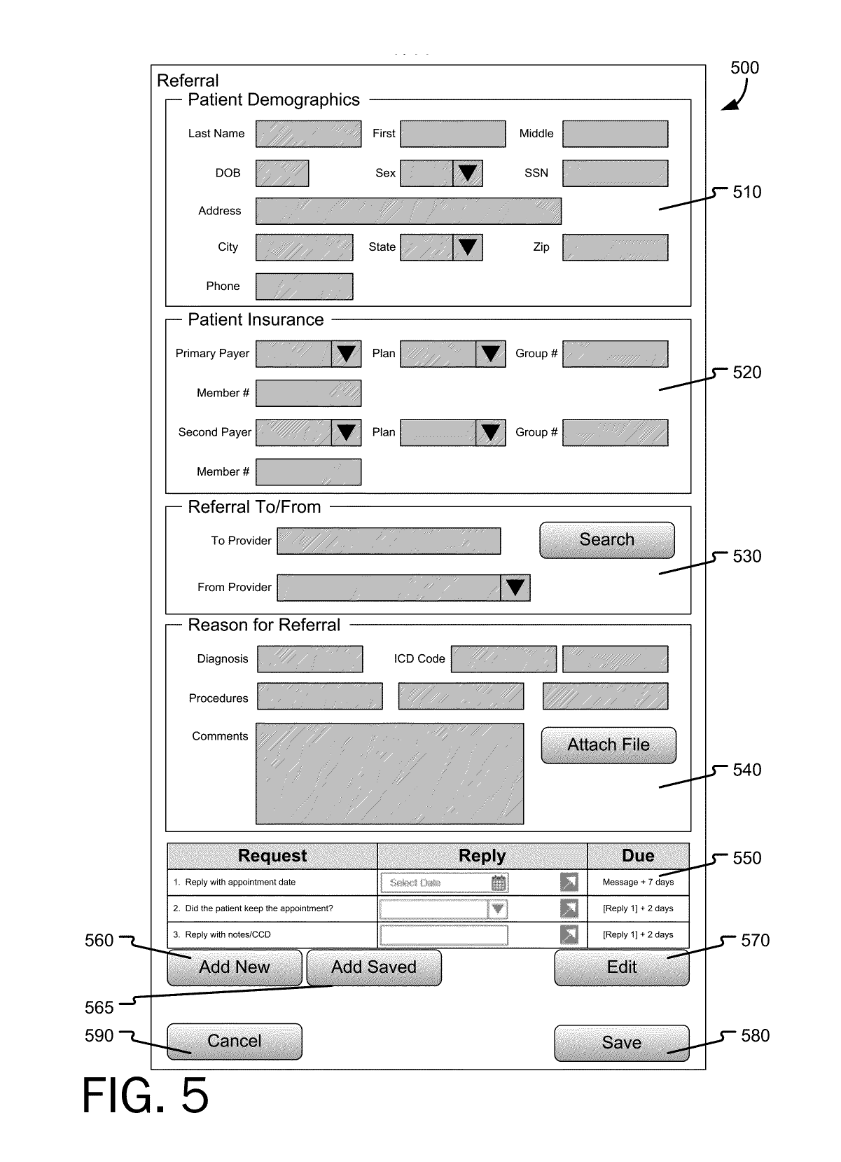

FIG. 5 is an example referring user interface (UI) 500 for building structured referrals. As will be understood, the example referring UI 500 shown in FIG. 5 is for purpose of illustration, and one of ordinary skill in the art would understand that different arrangements of UI elements and the provision for more or fewer data elements may be made by alternative Uls without departing from the scope of the present disclosure.

As illustrated in FIG. 5, the referring UI 500 includes multiple sections into which core data about the referral is entered by the sender, requests are added or edited, and controls for the referring UI 500 and sections are provided. Each of the sections include data that are logically linked together, and may be input by hand or automatically imported from another source. For example, a patient demographics section 510 may include information to identify a patient, a patient insurance section 520 may include information to identify the insurance carrier for the patient, a referral section 530 may include information to designate a healthcare provider to which the patient is being referred and the healthcare provider making the referral, a reason-for-referral section 540 may include diagnostic information related to the patient's continued care, and a requests section 550 may include requests that have been added to the referral. In various aspects, filling in information within a section by hand may result in the system filling in other data in the same or different sections based on the hand-inputted information. For example, filling in a patient name in the patient demographics section 510 may result in the sender's EMR database 140a pulling the patient insurance information to automatically fill out the patient insurance section 520. In another example, filling out the reason-for-referral section 540 may cause the structured referral system 110 to automatically populate the requests section 550 with saved requests based on the referral reason information and previously made referrals that included the same or similar referral reason information.

The requests section 550 enables the sender to specify the requests that are added to the referral for the receiver to fill out. The sender specifies the request, the structure by which the receiver may respond to the request, when a reply to the request is due, and the order in which requests are presented to the receiver. The requests section 550 may include user interface elements that the sender may select (e.g., via keyboard, mouse, or touchscreen input) to populate the requests section 550. As illustrated, an add-new request button 560 is provided so that the sender may create a new request for inclusion with the referral. Similarly, an add-saved request button 565 is provided so that the sender may include a previously created request with the referral. An edit request button 570 is also provided so that the sender may make changes, including deletions, to the requests that have been included with the referral. As will be understood, the selection of an add-new request button 560, an add-saved request button 565, or an edit request button 570 may launch a new window or a pop-up (e.g. a dialog box) to present options to the sender to select from when adding or editing a request.

A sender may save the referral for completion at a later date, or for completion and transmission to the receiver by selecting a save button 580. Alternatively, a sender may select a cancel button 590 to discard the referral or any changes made to an existing referral.

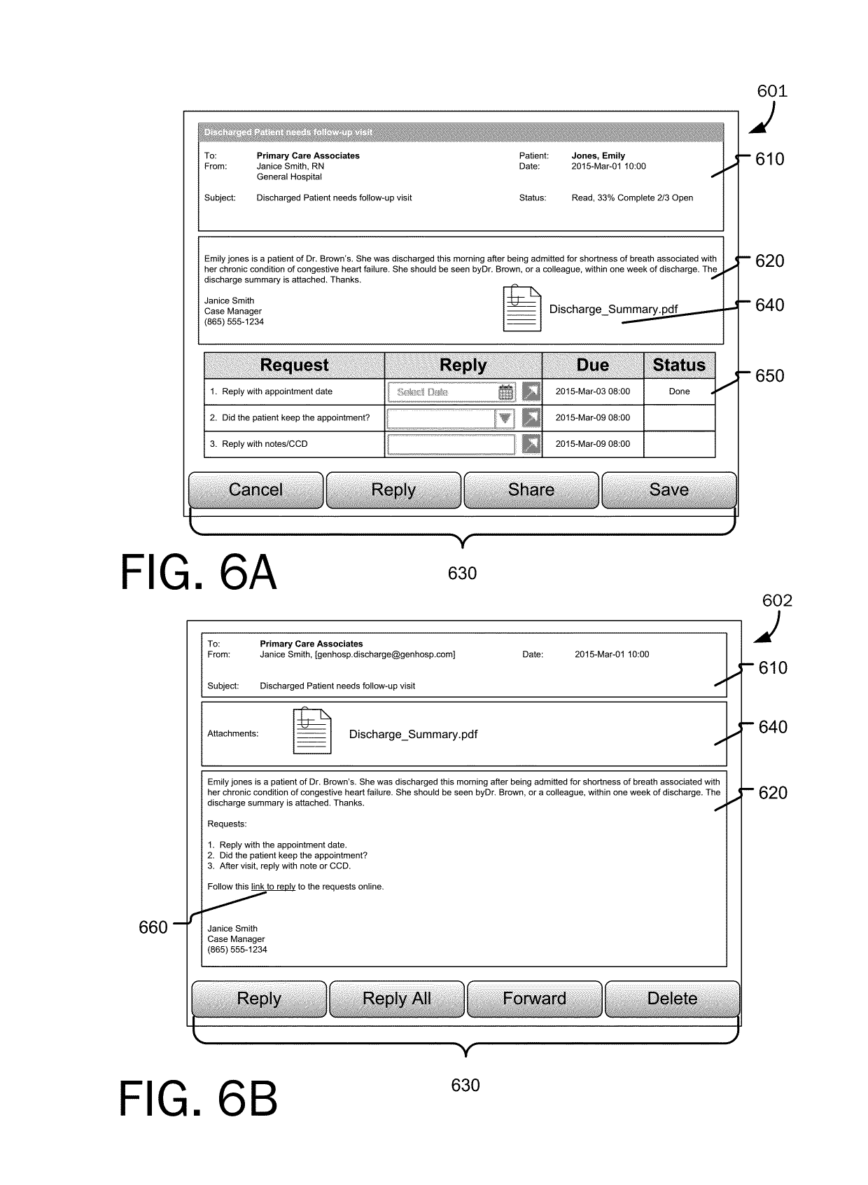

FIGS. 6A and 6B are example message Uls 601, 602 for a receiver to access a structured referral. As will be understood, the example message UIs 601, 602 shown in FIGS. 6A and 6B are for purpose of illustration, and one of ordinary skill in the art would understand that different arrangements of UI elements and the provision for more or fewer data elements may be made by alternative Uls without departing from the scope of the present disclosure.

FIG. 6A illustrates a system-message UI 601 accessed via a structured referral system 110 or the receiver's EMR database 140b that includes the referral and its requests. FIG. 6B illustrates an application-message UI 602 accessed via an application on the receiver's remote computer 120b. Both message UIs 601, 602 include several common features, including addressing information 610, message information 620, and messaging application functionalities 630. In various aspects, when the sender has attached a file, the message UIs 601, 602 may also present an attached document 640 for the receiver to download or access over the network 130 (e.g., via a shared cloud storage system). Depending on the characteristics of the system used to access the message, an attached document 640 may be provided in the message information 620 (as illustrated in FIG. 6A) or in a separate section for attachments (as illustrated in FIG. 6B).

Because system-message UI 601 is provided via a system that includes the referral and its requests, those requests may be incorporated in the message UI 601 as request controls 650 so that the receiver may respond directly to the requests within the system-message UI 601. In various aspects, when the request controls 650 are selected, the receiver may input data matching the reply type selected by the sender into the system-message UI 601, or a pop-up window may be provided so that the receiver may input the data matching the reply type.

In contrast to the system-message UI 601, the application-message UI 602 is provided an by application that does not have direct access to the referral, such as, for example, an email application or text messaging application on the receiver's remote computer 120b. Because the application-message UI 602 is provided via a system that does not include the referral or its requests, a hyperlink 660 is provided to the receiver instead of request controls 650 so that the receiver may access a system that does include the referral and its requests from the message. In various aspects, the hyperlink 660 directs the receiver to the system that includes the referral where the receiver is prompted to log in to access a system-message UI 601.

Depending on the security settings associated with messages transmitted outside of the EMR system or the structured referral system 110, such as, for example, emails, text messages, and pager messages, the message information 620 presented in an application-message UI 602 may vary from that presented in a system-message UI 601. As illustrated in FIG. 6B, the message information 620 may be fully presented and expanded to include information on the requests when security settings allow for potentially sensitive information, including personally identifiable information like names and diagnoses to be transmitted. Alternatively, the message information 620 in an application-message UI 602 may be reduced from the message information 620 presented in a system-message UI 601 depending on security settings or device capabilities. For example, the message information 620 in an application-message UI 602 may consist only of an alert that a new referral exists in the appropriate system. In various aspects, such an alert may be a hyperlink 660 to the system that includes the referral and requests.

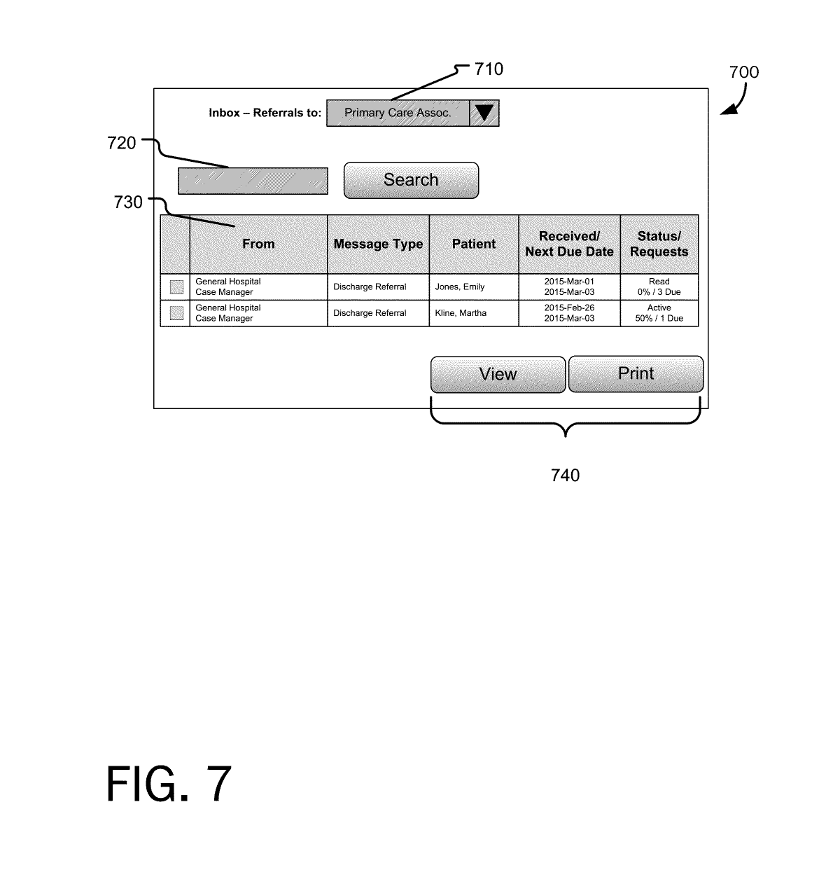

FIG. 7 is an example inbox UI 700 of a structured referral inbox for a receiver to check the status of received structured referrals. As will be understood, the example inbox UI 700 shown in FIG. 7 is for purpose of illustration, and one of ordinary skill in the art would understand that different arrangements of UI elements and the provision for more or fewer data elements may be made by alternative UIs without departing from the scope of the present disclosure.

In various aspects, a receiver may access the inbox UI 700 when logging into a structured referral system 110 or the receiver's EMR database 140b when it includes referrals. Additionally, the receiver may be directed to the inbox from a hyperlink 660 included in a message sent to an application not part of the system or directed the referral itself.

The inbox UI 700 provides controls for the receiver to view the referrals that have been sent to it from various senders of referrals. In the illustrated example, a receiver filter 710 is provided to adapt the referrals that are presented in the inbox UI 700. For example, a healthcare provider organization (e.g., Hospital ABC, Hospital XYZ), a location for a healthcare provider organization (e.g., office 1, office 2), or a healthcare provider professionals (e.g., Dr. Able, Dr. Baker) may be selected from the receiver filter 710 to adapt the display of referrals to the selected entity. For example, when “Hospital ABC” is selected in the receiver filter 710, all referrals sent to Hospital ABC are presented, whereas when “Doctor Able” is selected in the receiver filter 710, only referrals sent to Doctor Able are presented. A search control 720 is also provided to allow a user of the inbox UI 700 to specify text to search for in the referrals. For example, the text searched for may specify a sender, a condition, a note, a date or other custom refinement of which referrals to display in the referral presentation control 730.

A referral presentation control 730 is provided to display referrals meeting the restrictions placed by the receiver filter 710 and search control 720 to the receiver to view. The referrals may have several data parsed for display in distinct categories in the referral presentation control 730, such as, for example, the parties from which the referral was received, a message type, the patient referred, when the referral was received, the next due date for a request associated with the referral, the status of the referral, and a number of requests associated with the referral. The receiver may interact with the referral presentation control 730 to organize how the referrals are sorted, for example, one of the distinct categories may be chosen as the key category to sort a plurality of referrals by, and the receiver may choose a method for sorting under the key category (e.g., oldest first, newest first, A to Z, Z to A, Unread→Read→Active, Active→Unread→Read, Read→Active→Unread, Unread→Active→Read, Active→Read→Unread, Read→Unread→Active, most to least, least to most).

The receiver may interact with the referral presentation control 730 to access and interact with one or more of the displayed referrals via keyboard, touchscreen, mouse commands (e.g., click/tap to select, double click/tap to view, ctrl-O to view selected referrals, ctrl-P to print selected referrals) and/or via the inbox controls 740. In various aspects, the inbox controls 740 include UI elements (e.g., buttons) to perform specific tasks on selected referrals, such as, but not limited to, View, Print, Extract to a storage device or system, Delete, Forward and Refer to a third-party, and Set reminders. Some or all of these UI elements may be presented in different aspects of an inbox UI 700. Depending on the command or UI element selected, a new window or a pop-up may be provided to provide information to the receiver (e.g., open the referral for viewing via a system-message UI 601 such as that illustrated in FIG. 6A) or request additional information from the receiver (e.g., select a printer, set a reminder time and device/address).

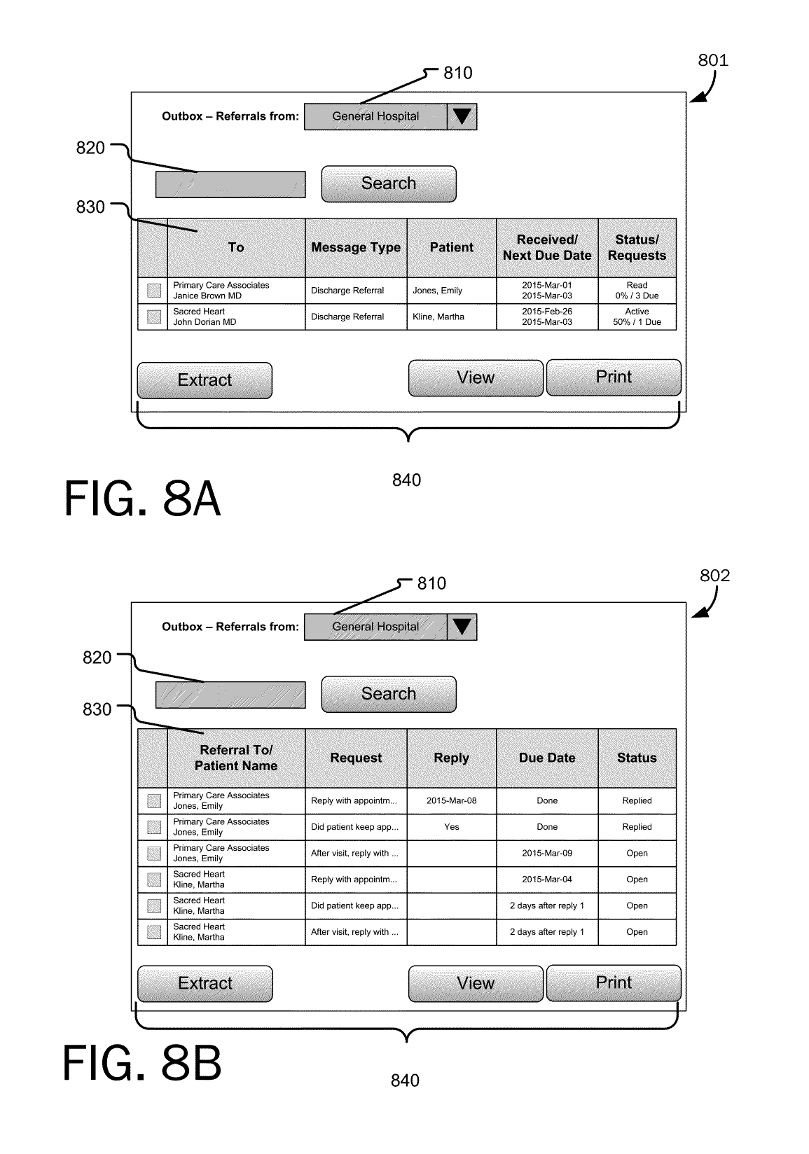

FIGS. 8A and 8B are example outbox Uls 801, 802 of a structured referral outbox for a sender to check the status of sent structured referrals. As will be understood, the example outbox UIs 801, 802 shown in FIGS. 8A and 8B are for purpose of illustration, and one of ordinary skill in the art would understand that different arrangements of UI elements and the provision for more or fewer data elements may be made by alternative UIs without departing from the scope of the present disclosure.

FIG. 8A illustrates a referral-view outbox UI 801 and FIG. 8B illustrates a request-view outbox UI 802. Both outbox UIs 801, 802 include several common features, including sender filter 810, search control 820, and reply presentation control 830, and outbox controls 840, although the data displayed by the reply presentation control 830 is organized differently in each of the outbox UIs 801, 802. Other arrangements of the display of data displayed by the reply presentation control 830 than those illustrated are possible and a sender may freely switch between the referral-view outbox UI 801 and the request-view outbox UI 802 or any other views of the outbox information.

Sender filter 810 is provided to adapt the replies (or lack thereof) that are presented in the outbox UIs 801, 802. For example, a healthcare provider organization (e.g., Hospital ABC, Hospital XYZ), a location for a healthcare provider organization (e.g., office 1, office 2), or a healthcare provider professionals (e.g., Dr. Able, Dr. Baker) may be selected from the sender filter 810 to adapt the display of replies to referrals sent by the selected entity. For example, when “Hospital ABC” is selected in the sender filter 810, all replies to all referrals originating from Hospital ABC are presented, whereas when “Doctor Able” is selected in the sender filter 810, only replies to referral originating from Doctor Able are presented. A search control 820 is also provided to allow a user of the outbox UIs 801, 802 to specify text to search for in the replies. For example, the text searched for may specify a receiver, a condition, a note, a date or other custom refinement of which replies to display in the in the reply presentation control 830.

A reply presentation control 830 is provided to display replies meeting the restrictions placed by the sender filter 810 and search control 820 to the sender to view. The replies may have several data parsed for display in distinct categories in the reply presentation control 830, such as, for example, the parties to which the referral was sent, a message type, a request type, the response to the request (or lack thereof), the patient referred, when the referral was received, the next due date for a request associated with the referral, the status of the referral, and a number of requests associated with the referral. The sender may interact with the reply presentation control 830 to organize how the replies are sorted, for example, one of the distinct categories may be chosen as the key category to sort a plurality of referrals by, and the sender may choose a method for sorting under the key category (e.g., oldest first, newest first, A to Z, Z to A, Unread→Read→Active, Active→Unread→Read, Read→Active→Unread, Unread→Active→Read, Active→Read→Unread, Read→Unread→Active, most to least, least to most).

The sender may interact with the reply presentation control 830 to access and interact with one or more of the displayed referrals or replies via keyboard, touchscreen, mouse commands (e.g., click/tap to select, double click/tap to view, ctrl-O to view selected referrals, ctrl-P to print selected referrals) and/or via the outbox controls 840. In various aspects, the outbox controls 840 include UI elements (e.g., buttons) to perform specific tasks on selected referrals and replies, such as, but not limited to, View, Print, Extract to a storage device or system, Delete, Forward and Refer to a third-party, and Set reminders. Some or all of these UI elements may be presented in different aspects of the outbox Uls 801, 802. Depending on the command or UI element selected, a new window or a pop-up may be provided to provide information to the sender (e.g., open the reply for viewing, switch between UIs) or request additional information from the sender (e.g., select a printer, set a reminder time and device/address).

FIG. 9 is a block diagram illustrating physical components of an example computing device with which aspects may be practiced. The computing device 900 may include at least one processing unit 902 and a system memory 904. The system memory 904 may comprise, but is not limited to, volatile (e.g. random access memory (RAM)), non-volatile (e.g. read-only memory (ROM)), flash memory, or any combination thereof. System memory 904 may include operating system 905, one or more programming modules 906, and may include a structured referral system 110 having sufficient computer-executable instructions, which when executed, perform functionalities as described herein. Operating system 905, for example, may be suitable for controlling the operation of computing device 900. Furthermore, aspects may be practiced in conjunction with a graphics library, other operating systems, or any other application program and is not limited to any particular application or system. This basic configuration is illustrated by those components within a dashed line 908. Computing device 900 may also include one or more input device(s) 912 (keyboard, mouse, pen, touch input device, etc.) and one or more output device(s) 914 (e.g., display, speakers, a printer, etc.).

The computing device 900 may also include additional data storage devices (removable or non-removable) such as, for example, magnetic disks, optical disks, or tape. Such additional storage is illustrated by a removable storage 909 and a non-removable storage 910. Computing device 900 may also contain a communication connection 916 that may allow computing device 900 to communicate with other computing devices 918, such as over a network in a distributed computing environment, for example, an intranet or the Internet. Communication connection 916 is one example of a communication medium, via which computer-readable transmission media (i.e., signals) may be propagated.

Programming modules, may include routines, programs, components, data structures, and other types of structures that may perform particular tasks or that may implement particular abstract data types. Moreover, aspects may be practiced with other computer system configurations, including hand-held devices, multiprocessor systems, microprocessor-based or programmable user electronics, minicomputers, mainframe computers, and the like. Aspects may also be practiced in distributed computing environments where tasks are performed by remote processing devices that are linked through a communications network. In a distributed computing environment, programming modules may be located in both local and remote memory storage devices.

Furthermore, aspects may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SoC)). Aspects may also be practiced using other technologies capable of performing logical operations such as, for example, AND, OR, and NOT, including, but not limited to, mechanical, optical, fluidic, and quantum technologies. In addition, aspects may be practiced within a general purpose computer or in any other circuits or systems.

Aspects may be implemented as a computer process (method), a computing system, or as an article of manufacture, such as a computer program product or computer-readable storage medium. The computer program product may be a computer storage medium readable by a computer system and encoding a computer program of instructions for executing a computer process. Accordingly, hardware or software (including firmware, resident software, micro-code, etc.) may provide aspects discussed herein. Aspects may take the form of a computer program product on a computer-usable or computer-readable storage medium having computer-usable or computer-readable program code embodied in the medium for use by, or in connection with, an instruction execution system.

Although aspects have been described as being associated with data stored in memory and other storage mediums, data can also be stored on or read from other types of computer-readable storage media, such as secondary storage devices, like hard disks, floppy disks, or a CD-ROM, or other forms of RAM or ROM. The term computer-readable storage medium refers only to devices and articles of manufacture that store data or computer-executable instructions readable by a computing device. The term computer-readable storage medium does not include computer-readable transmission media.

Aspects of the present invention may be used in various distributed computing environments where tasks are performed by remote processing devices that are linked through a communications network.

Aspects of the invention may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented with computing device 900 or any other computing devices 918, in combination with computing device 900, wherein functionality may be brought together over a network in a distributed computing environment, for example, an intranet or the Internet, to perform the functions as described herein. The systems, devices, and processors described herein are provided as examples; however, other systems, devices, and processors may comprise the aforementioned memory storage and processing unit, consistent with the described aspects.

The description and illustration of one or more aspects provided in this application are intended to provide a thorough and complete disclosure the full scope of the subject matter to those skilled in the art and are not intended to limit or restrict the scope of the invention as claimed in any way. The aspects, examples, and details provided in this application are considered sufficient to convey possession and enable those skilled in the art to practice the best mode of the claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, aspects, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept provided in this application that do not depart from the broader scope of the present disclosure.

We claim:

1. A system for ensuring closed-loop communications between healthcare providers by specifying a structure by which to respond to a referral, comprising:
a processor and a memory storage device including instructions, which when executed by the processor are operable to:
receive, from a sender's remote computer, the referral for a patient to a receiving healthcare provider, wherein the referral is an electronic document including electronic clinical documents (ECD) related to the patient;
receive a request to associate with the referral, wherein the request specifies the structure by which the receiving healthcare provider is to respond to the request and thereby respond to the referral;
provide access to the referral and the associated request to a receiver's remote computer associated with the receiving healthcare provider;
determine whether the receiving healthcare provider has responded to the request associated with the referral; and
when it is determined that the receiving healthcare provider has not responded to the request, generate a message to prompt the receiving healthcare provider to respond to the referral, and transmit the message to the receiving healthcare provider.

2. The system of claim 1, wherein the system is further operable to:
when it is determined that the receiving healthcare provider has responded to the request, transmit the ECD related to the patient to the receiver's remote computer.

3. The system of claim 1, wherein the ECD is encrypted and the receiver's remote computer is provided access to the encrypted ECD when access is provided to the referral; and
when it is determined that the receiving healthcare provider has responded to the request, the system is further operable to transmit a key to decrypt the encrypted ECD to the receiver's remote computer.

4. The system of claim 1, wherein the system is further operable to:
determine whether the patient has complied with a course of treatment indicated in the referral based on a response to the referral from the receiving healthcare provider; and
when it is determined that the patient has not complied with the course of treatment, transmitting a contact message to a patient device associated with the patient.

5. The system of claim 4, wherein the contact message transmitted to the patient device activates a messaging program to cause the patient device to display the message.

6. The system of claim 1, wherein the receiving healthcare provider responds to the referral by reassigning the referral to a different receiving healthcare provider.

7. A method for ensuring closed-loop communications between healthcare providers by specifying a structure by which to respond to a referral, comprising:
generating the referral to refer a patient to a receiving healthcare provider;
associating a request with the referral, wherein the request specifies the structure by which the receiving healthcare provider is to reply to the referral, wherein the structure includes a due date for the receiving healthcare provider to reply to the referral;
saving the referral with the associated request in a database;
contacting the receiving healthcare provider with the referral;
determining whether the receiving healthcare provider has replied to the referral by the due date; and
when the receiving healthcare provider has not replied to the referral by the due date, transmitting a message to the receiving healthcare provider to prompt the receiving healthcare provider to respond to complete the referral by replying to the request.

8. The method of claim 7, wherein the receiving healthcare provider responds to the referral by reassigning the referral to a different receiving healthcare provider.

9. The method of claim 7, wherein the due date is set based on a response date of a prior reply.

10. The method of claim 7, wherein the referral includes multiple requests; and
when the receiving healthcare provider has replied to at least one, but not all, of a plurality of requests included by the referral, adding a reminder to the referral to alert the receiving healthcare provider to reply to any requests not yet replied to at a later date.

11. The method of claim 10, wherein at the later date, the reminder activates a pop-up window on a remote computer of the receiving healthcare provider to cause the remote computer to display the reminder at the later date.

12. The method of claim 7, wherein the referral includes a hyperlink to enable the receiving healthcare provider to respond to the referral.

13. A method for ensuring closed-loop communications between healthcare providers by structuring a referral with a request for a receiver to respond to, comprising:
receiving, from a sender, the referral for a patient to the receiver, wherein the referral is an electronic document indicating a continuing course of treatment for the patient;
receiving, from the sender, the request associated with the referral, wherein the request specifies a structure by which the receiver is to respond to the request and thereby respond to the referral;
providing the receiver with access to the referral and the request;
determining whether the receiver has responded to the request with a reply;
when it is determined that the receiver has not responded to the request, generating a message to prompt the receiver to respond to the request, and transmitting the message to the receiver;
when it is determined that the receiver has responded to the request,
providing the receiver with access to an electronic clinical document related to the referral for the patient;
determining from the reply to the request whether the patient has complied with the continuing course of treatment; and
when it is determined that the patient has not complied with the continuing course of treatment, transmitting a contact message to a device associated with the patient.

14. The method of claim 13, wherein the electronic clinical document is provided to the receiver in an encrypted form and wherein providing access to the electronic clinical document comprises providing the receiver a key to decrypt the electronic clinical document from the encrypted form.

15. The method of claim 13, wherein providing access to the electronic clinical document further comprises:
sending the electronic clinical document to the receiver, wherein the electronic clinical document is not sent to the receiver until the receiver responds to the referral.

16. The method of claim 13, wherein the referral includes multiple requests; and
when the receiver has replied to at least one, but not all, of the multiple requests included by the referral, adding a reminder to the referral to alert the receiver to reply to any requests not yet replied to at a later date.

17. The method of claim 16, wherein the reminder activates a pop-up window on a remote computer of the receiver to cause the remote computer to display the reminder at the later date.

18. The method of claim 13, wherein the referral includes a hyperlink to enable the receiving healthcare provider to respond to the referral.

19. The method of claim 13, wherein the contact message transmitted to the device associated with the patient activates a messaging program to cause the device associated with the patient to display the contact message.

20. The method of claim 13, further comprising:
determining whether the receiver has accessed the referral; and
when it is determined that the receiver has accessed the referral, generating a read receipt and transmitting the read receipt to the sender.
